(19) United States
(12) Patent Application Publication
(10) Pub. No.: US 2007/0137814 A1
(43) Pub. Date: Jun. 21, 2007

(54) Tissue sheet molded with elevated elements and methods of making the same

(75) Inventor: Hongxia Gao, Appleton, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/303,008

(22) Filed: Dec. 15, 2005

(51) Int. Cl. B31F 1/07; D21H 27/00

(52) U.S. Cl. 162/117; 162/109; 162/205; 428/156

(57) ABSTRACT

A paper web having discrete elevated elements molded in the z-direction is generally disclosed, along with methods of making the same. The molded web has improved bulk retention when subjected to compression in the z-direction. The discrete elevated elements can be dome-shaped elevated elements and/or elevated elements having at least one vertical sidewall to form an aesthetically pleasing figure. The paper web can be an uncreped through air dried paper web. The molding of the paper web can result from the contour of the dryer fabric, such as a nonwoven dryer fabric.

### BACKGROUND OF THE INVENTION

Consumers use paper wiping products, such as tissues, for a wide variety of applications. For example, various types of tissues can be used for applications, such as for nose care, cosmetics, eyeglass cleaning, etc. Typically, a user of such tissues requires that the tissues possess a relatively soft feel. In the past, various mechanisms have been utilized to produce tissues having a soft feel. For example, in many cases, a tissue is softened through the application of a chemical additive (i.e., softener) that is capable of enhancing the soft feel of the tissue product. Moreover, in other instances, a side of the tissue is imparted with domes to provide a softer feel.

In the past, domes were typically imparted onto a tissue surface by the application of pressure, such as in an embossing process. However, tissue products having domes formed by embossing and other pressure techniques are susceptible to a substantial loss of bulk when a compression pressure is applied to the tissue product. As such, these tissue products have a poor bulk retention when a pressure is applied to it.

Additionally, if domes were included in the tissue product, the domes were arranged in rows extending in the cross-machine direction (CD), the machine direction (MD), or at an angle to either the CD or MD direction.

As such, a need currently exists for an improved tissue product that possesses a soft feel and has a good bulk retention when applied with a pressure. Furthermore, a need exists for a web with these improved properties having a pleasing aesthetic appearance.

### SUMMARY OF THE INVENTION

Objects and advantages of the invention will be set forth in part in the following description, or may be obvious from the description, or may be learned through practice of the invention.

In general, the present disclosure is directed to a tissue product having discrete elevated elements. For example, in one embodiment, the elevated elements can have at least one vertical sidewall. In other embodiments, the elevated elements can be dome-shaped. In some embodiments, the elevated elements can be a combination of the differently shaped elevated elements. By including differently shaped elevated elements, the present inventors have discovered that the webs bulk retention can be adjusted to a desired amount.

The elevated elements can be arranged in designs or figures to impart an aesthetically appealing appearance to the web. For instance, in one embodiment, the designs or figures can be registered between perforations on the web.

By molding the paper webs with discrete elevated elements, the paper web can have improved bulk retention when subjected to a load in the z-direction. For example, the paper web can retain at least about 75% of its bulk when subjected to a pressure of about 0.3 PSI. Alternatively, or in addition to, the web can retain at least about 65% of its bulk when subjected to a pressure of about 0.5 PSI.

In another embodiment, the present invention is generally directed to a method of forming a molded tissue product having improved bulk retention. In one particular embodiment, for example, the tissue can be formed utilizing a technique known as uncreped through-air drying.

The through-air dryer can contain a device for molding elevated elements into the tissue. For example, the device can be a patterned fabric (woven or nonwoven) wrapped around the through-air dryer. In one embodiment, a through-air drying fabric can be utilized that has certain protrusions of a pitch depth greater than about 0.1 mm, particularly between about 0.5 to about 2 mm, and more particularly between about 0.8 to about 1.2 mm; and a pitch width greater than about 0.1 mm, particularly between about 0.5 to about 5 mm, and more particularly between about 1 to about 2.5 mm.

In some embodiments, other devices, such as a pressure roll, can also be utilized to apply pressure to one or more surfaces of the tissue. For instance, in one embodiment, a pressure roll can press the tissue against the through-air dryer as the tissue travels through a nip. The pressure roll can have a smooth or patterned surface, or can have a smooth or patterned fabric wrapped around the roll. Moreover, in some embodiments, the pressure roll can apply a pressure less than about 60 pounds per square inch (psi), and particularly between about 35 to about 40 psi, to one or more surfaces of the tissue.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 is a schematic diagram of one embodiment for molding elevated elements onto the surface of the tissue of the present invention;

FIG. 2 is an exemplary embodiment of a design pattern in a tissue sheet of the present invention;

FIG. 3 is another exemplary embodiment of a design pattern in a tissue sheet of the present invention;

FIG. 4 is an exemplary embodiment of a perforated tissue product of the present invention;

FIGS. 5(a-f) show several exemplary geometries of discrete element structures;

FIG. 6 is a chart showing the compression stress-caliper results of several different structures with different element shape; and

FIG. 7 is a chart showing the compression stress-caliper results of Example 1.

Repeat use of reference characters in the present specification and drawings is intended to represent the same or analogous features or elements of the present invention.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

In general, the present disclosure is directed to a tissue product having discrete elevated elements molded into the tissue web. As used herein, “elevated elements” generally refer to any type of shape imparted onto a tissue surface including, but not limited to, domes, parabola, hyperbola, inverted cones, cylinders, donut-shaped extrusions, star-shaped extrusions, and combinations thereof or variable contour shapes.

For example, in one particular embodiment, dome-shaped and/or other shaped elevated elements can be molded into the tissue web. For example, the elevated elements may have at least one substantially vertical sidewall (i.e. substantially in the z-direction of the sheet, which is the direction 90° from the surface of the sheet). The dome-shaped and/or other shaped elevated elements can increase the bulk of the tissue product, including both the sheet bulk of the tissue web and the roll bulk (or stack bulk) of a tissue product formed from the tissue web.

By molding the tissue web with discrete elevated elements, it has been discovered that the tissue web can have a variety of improved characteristics, such as improved softness, sheet bulk, roll bulk, and bulk retention. Bulk retention is the ability of a web to retain its bulk, either roll bulk or sheet bulk, over time and in different environments with different stresses. Compression resistance of a topographic sheet can have a significant impact on bulk retention. Compression resistance is the ability of a sheet to retain its bulk in the z-direction under a compression force or load on the sheet in the z-direction.

When a topographic sheet is compressed, the caliper of the sheet decreases because the discrete elements collapse as the load increases. Severe compression on the structure will cause permanent plastic deformation on the sheets that will not be recovered once the load is removed. However, according to the present disclosure, the dome-shaped and/or other shaped elevated elements can help reduce the permanent deformation by resisting compression when a compressing force is applied to the sheet.

For example, in one embodiment, tissue webs having dome-shaped elevated elements can retain at least about 75% of its bulk in the z-direction under a pressure of about 0.3 PSI, such as at least about 80% of its bulk. For instance, in one particular embodiment, the tissue web can retain at least about 85% of its bulk under a pressure of about 0.3 PSI.

In another example, in one embodiment, tissue webs having dome-shaped elevated elements can retain at least about 65% of its bulk in the z-direction under a pressure of about 0.5 PSI, such as at least about 70% of its bulk. For instance, in one particular embodiment, the tissue web can retain at least about 75% of its bulk under a pressure of about 0.5 PSI.

In other embodiments having discrete elevated elements having at least one substantially vertical sidewall, the tissue web can have improved bulk retention over sheets with dome-shaped elevated elements. Examples of discrete elements having at least one vertical sidewall include, but are not limited to, donut-shaped elevated elements, cylindrically shaped elevated elements, star-shaped elevated elements, block-shaped elevated elements, a combination of circular domes and cylinders shaped elevated elements and the like.

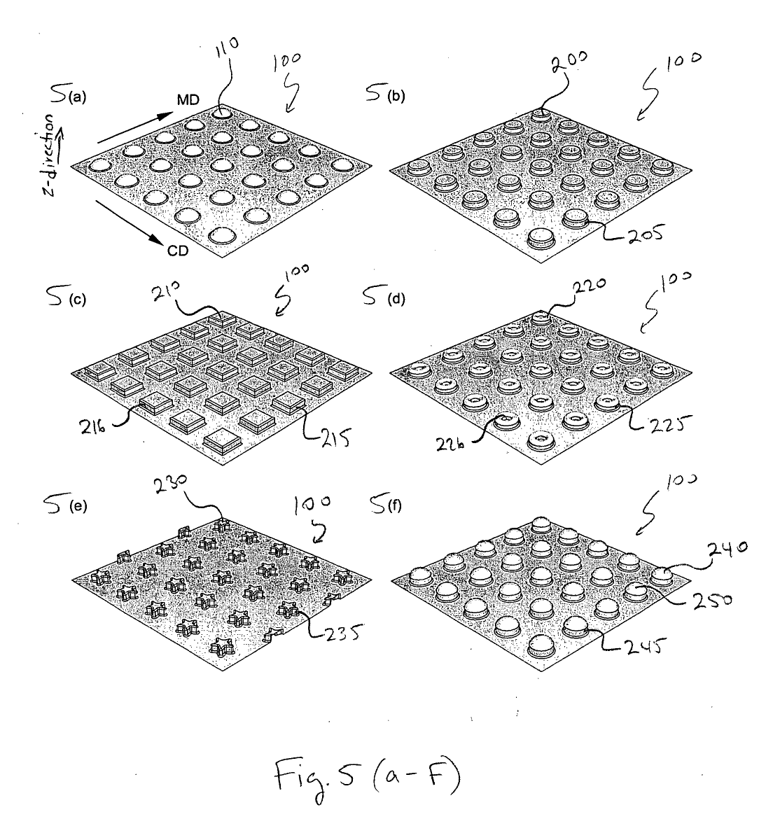

For example, a tissue web having donut-shaped elevated elements, such as those depicted in FIG. 5(d), can retain at lease about 97% of its caliper under a load of about 0.3 psi. A tissue web having donut-shaped elevated elements can retain at lease about 95% of its caliper under a load of about 0.5 psi.

In general, any of a variety of tissues or other types of paper webs can be formed with elevated elements in accordance with the present invention. For example, the tissue can be a single or multi-ply tissue. Normally, the basis weight of a tissue of the present invention is less than about 120 grams per square meter (gsm), particularly less than about 60 gsm, particularly from about 10 to about 50 gsm, and more particularly between about 15 to about 35 gsm.

Moreover, a tissue of the present invention can generally be formed from any of a variety of materials. In particular, a variety of natural and/or synthetic fibers can be used. For example, some suitable natural fibers can include, but are not limited to, nonwoody fibers, such as abaca, sabai grass, milkweed floss fibers, pineapple leaf fibers; softwood fibers, such as northern and southern softwood kraft fibers; and hardwood fibers, such as eucalyptus, maple, birch, aspen, and the like. Illustrative examples of other suitable pulps include southern pines, red cedar, hemlock, and black spruce. Exemplary commercially available long pulp fibers suitable for the present invention include those available from Kimberly-Clark Corporation under the trade designations “Longlac-19”. In addition, furnishes including recycled fibers may also be utilized. Moreover, some suitable synthetic fibers can include, but are not limited to, hydrophilic synthetic fibers, such as rayon fibers and ethylene vinyl alcohol copolymer fibers, as well as hydrophobic synthetic fibers, such as polyolefin fibers.

One particular embodiment for forming a tissue of the present invention will now be described. Specifically, the embodiment described below relates to one method for forming the tissue of the present invention with elevated elements utilizing a papermaking technique known as uncreped through-drying. Examples of such a technique are disclosed in U.S. Pat. No. 5,048,589 to Cook, et al.; U.S. Pat. No. 5,399,412 to Sudall, et al.; U.S. Pat. No. 5,510,001 to Hermans, et al.; U.S. Pat. No. 5,591,309 to Rugowski, et al.; and U.S. Pat. No. 6,017,417 to Wendt, et al., which are incorporated herein in their entirety by reference thereto. Uncreped through-air drying generally involves the steps of: (1) forming a furnish of cellulosic fibers, water, and optionally, other additives; (2) depositing the furnish on a traveling foraminous belt, thereby forming a fibrous web on top of the traveling foraminous belt; (3) subjecting the fibrous web to through-drying to remove the water from the fibrous web; and (4) removing the dried fibrous web from the traveling foraminous belt.

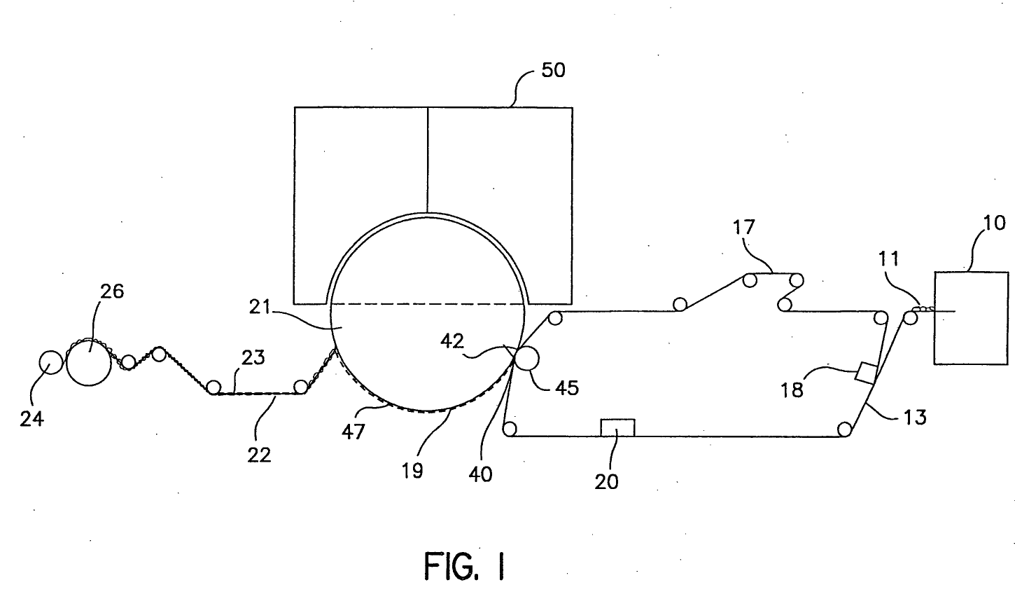

For example, referring to FIG. 1, one embodiment of a papermaking machine that can be used in the present invention is illustrated. For simplicity, the various tensioning rolls schematically used to define the several fabric runs are shown but not numbered. As shown, a papermaking headbox 10 can be used to inject or deposit a stream of an aqueous suspension of papermaking fibers onto a forming fabric 13, which serves to support and carry the newly-formed wet web 11 downstream in the process as the web is partially dewatered to a consistency of about 10 dry weight percent. Additional dewatering of the wet web can be carried out, such as by vacuum suction, while the wet web is supported by the forming fabric. The headbox 10 may be a conventional headbox or may be a stratified headbox capable of producing a multilayered unitary web. Further, multiple headboxes may be used to create a layered structure, as is known in the art.

Forming fabric 13 can generally be made from any suitable porous material, such as metal wires or polymeric filaments. Suitable fabrics can include, but are not limited to, Albany 84M and 94M available from Albany International of Albany, N.Y.; Asten 856, 866, 892, 959, 937 and Asten Synweve Design 274, available from Asten Forming Fabrics, Inc. of Appleton, Wis. The fabric can also be a woven fabric as taught in U.S. Pat. No. 4,529,480 to Trokhan, which is incorporated herein in its entirety by reference thereto. Forming fabrics or felts comprising nonwoven base layers may also be useful, including those of Scapa Corporation made with extruded polyurethane foam such as the Spectra Series. Relatively smooth forming fabrics can be used, as well as textured fabrics suitable for imparting texture and basis weight variations to the web. Other suitable fabrics may include Asten 934 and 939, or Lindsey 952-S05 and 2164 fabric from Appleton Mills, Wis.

The wet web 11 is then transferred from the forming fabric 13 to a transfer fabric 17. As used herein, a “transfer fabric” is a fabric which is positioned between the forming section and the drying section of the web manufacturing process. The transfer fabric 17 typically travels at a slower speed than the forming fabric 13 in order to impart increased stretch into the web. The relative speed difference between the two fabrics can be from 0% to about 80%, particularly greater than about 10%, more particularly from about 10% to about 60%, and most particularly from about 10% to about 40%. This is commonly referred to as “rush” transfer. One useful method of performing rush transfer is taught in U.S. Pat. No. 5,667,636 to Engel et al., which is incorporated herein in its entirety by reference thereto.

Transfer may be carried out with the assistance of a vacuum shoe 18 such that the forming fabric 13 and the transfer fabric 17 simultaneously converge and diverge at the leading edge of the vacuum slot. For instance, the vacuum shoe 18 can supply pressure at levels between about 10 to about 25 inches of mercury. The vacuum transfer shoe 18 (negative pressure) can be supplemented or replaced by the use of positive pressure from the opposite side of the web to blow the web onto the next fabric. In some embodiments, other vacuum shoes, such as a vacuum shoe 20, can also be utilized to assist in drawing the fibrous web 11 onto the surface of the transfer fabric 17. During rush transfer, the consistency of the fibrous web 11 can vary. For instance, when assisted by the vacuum shoe 18 at vacuum level of about 10 to about 25 inches of mercury, the consistency of the web 11 may be up to about 35% dry weight, and particularly between about 15% to about 30% dry weight.

From the transfer fabric 17, the fibrous web 11 is then transferred to the through-air dryer 21, optionally with the aid of a vacuum transfer shoe 42 or roll. The vacuum transfer roll or shoe 42 (negative pressure) can also be supplemented or replaced by the use of positive pressure from the opposite side of the web to blow the web onto the next fabric. The web 11 is typically transferred from the transfer fabric 17 to the through-air dryer 21 at the nip 40 at a consistency less than about 60% by weight, and particularly between about 25% to about 50% dry weight. In some embodiments, as shown in FIG. 1, a pressure roll 45 can be utilized to press the web 11 against the through-air dryer 21 at a nip 40. The roll 45 can be of made any of a variety of materials, such as of steel, aluminum, magnesium, brass, or hard urethane.

According to the present disclosure, the through-air dryer 21 is also provided with a through-air drying fabric 19, such as depicted in FIG. 1. The through-air drying fabric 19 can travel at about the same speed or a different speed relative to the transfer fabric 17. For example, if desired, the through-air drying fabric 19 can run at a slower speed to further enhance stretch.

As stated, the through-air drying fabric 19 is provided with various protrusions or impression shapes to mold the tissue web with elevated elements. The through-air drying fabric 19 may be woven or nonwoven fabric. In one particular embodiment, the through-air drying fabric 19 is a nonwoven fabric. Current woven fabrics have design restrictions that prevent the desirable structures and aesthetic patterns from imparting to the sheet. For woven fabrics, the dimensions of the topographic features (e.g. ripple width and height) are highly correlated because the structure is created by circular cross-section filaments. As filament diameter increases both height and width will increase, and some complex patterns may not be obtained because of the constraints on the weaving process. However, non-woven fabrics break this limitation so virtually any three-dimensional topographic pattern is possible to be imparted. A non-woven tissue machine fabric can be made from any of a variety of suitable porous materials, such as a high temperature nonwoven materials and a variety of polymetric substrates. 3-D topography can be imparted to the top surface of this fabric through molding or pressing it against a topographic surface. By having much more flexibility with aesthetics, non-woven fabrics can mold UCTAD tissue with 3-D topographies unobtainable from woven fabric with pleasing appearance and potential improved tissue properties for consumer preference and satisfaction.

In general, the patterned through-air drying fabric 19 can have any pattern desired. For instance, protrusions 47 of the through-air drying fabric 19 may mold the fibrous web 11 with an aesthetically appealing design. Any aesthetically pleasing design or pattern may be used in accordance with the present disclosure.

For example, any design or pattern can be formed by the elevated elements according to the present disclosure. The designs or patterns can be aesthetically pleasing to persuade a consumer to purchase the tissue product. For example, in one embodiment, the tissue product can have designs or patterns that indicate or celebrate a particular holiday or time of the year. The present inventors have discovered that the distribution of the elements has no substantial effect on the compressibility

The pattern can be centrally located on a tissue sheet such that the majority of the density of the elevated elements are located toward the center of the tissue sheet (i.e. toward the center of the MD direction and the center of the CD direction). For instance, the edges of the tissue sheet can have substantially no elevated elements, while the center of the tissue sheet can have at least about 25 elevated elements per sq. inch, such as about 30.

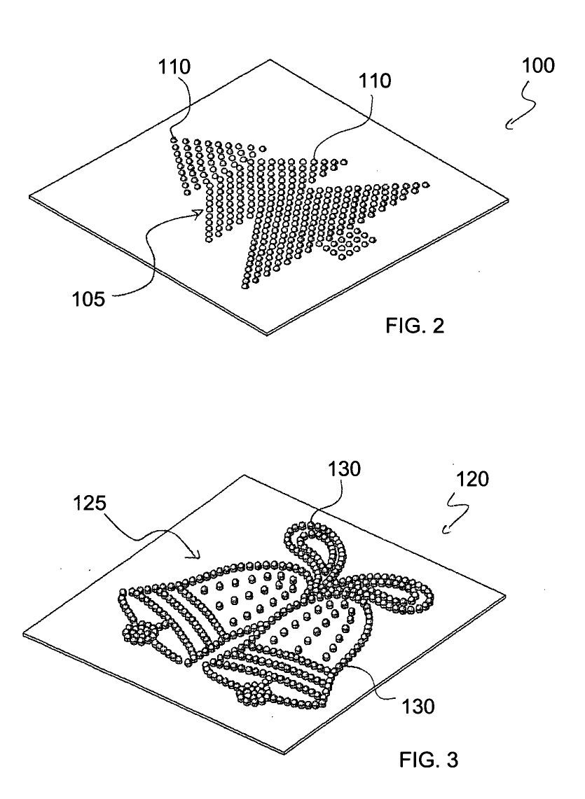

In one embodiment, the pattern can be in the shape of a figure. Referring to the exemplary embodiment represented by FIG. 2, tissue sheet 100 is shown with a Christmas tree-like design 105 that is defined by dome-shaped elevated elements 110. Also, in another example, FIG. 3 depicts tissue sheet 120 having an aesthetically design of a pair of bells 125 made of cylinder-stacked dome-shaped elevated elements 130.

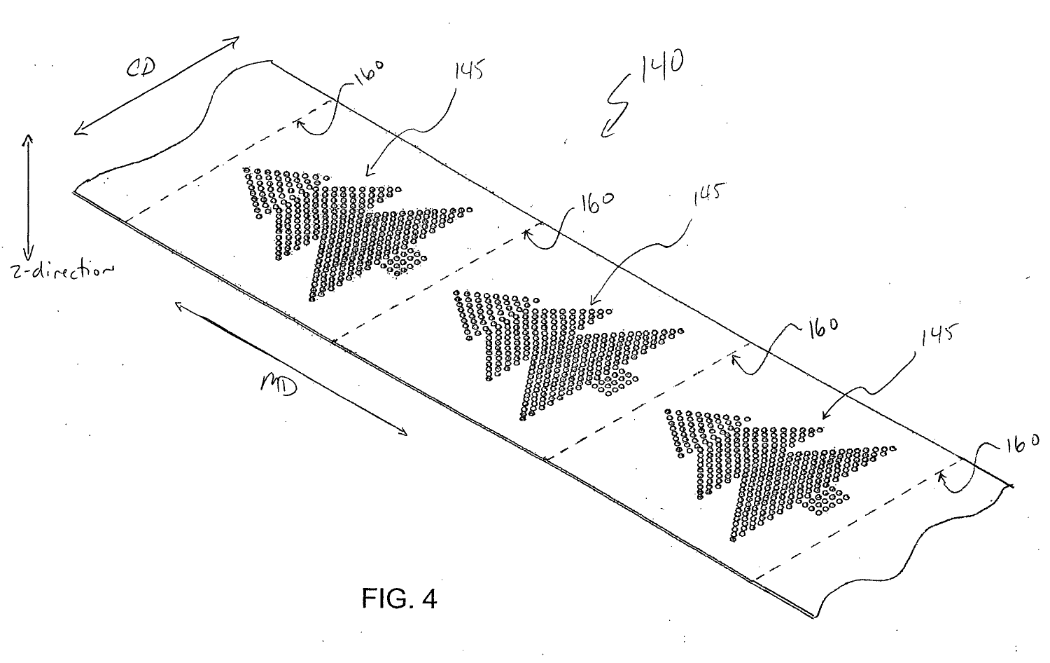

In both embodiments shown in FIGS. 2 and 3, designs 105 and 125 are registered between the edges of tissue sheet 110 and 120, respectively. For example, when the tissue sheets are part of a rolled tissue product, such as shown in FIG. 4, design 145 can be registered between perforations 160 on the tissue product 140. In some embodiments, more than one design can be located on each tissue sheet and still be registered between perforations 160. For example, perforations 160 can be situated in the cross-machine direction and repeating in the machine direction in substantially evenly spaced intervals. For example, a typical bath tissue product has tissue web of about a 4.5 inches wide in the cross-machine direction, with its tissue sheets separated by perforations 160 such that each tissue sheet has a length of about 4 inches in the machine direction.

Dome-shaped elevated elements have the ability to retain the bulk of the tissue sheet when a compression force is applied in the z-direction. Without wishing to be bound by theory, it is believed that dome-shaped elevated elements provide the web with improved compression resistance, resulting in improved bulk retention. For example, when a web defining dome-shaped elevated elements is subjected to a pressure of about 0.3 psi in the z-direction, the web can retain at least about 75% of its initial bulk, such as at least about 85%. Also, when the web is subjected to a pressure in the z-direction of about 0.5 psi, the web can retain at least about 65% of its initial bulk, such as at least about 70% of its initial bulk.

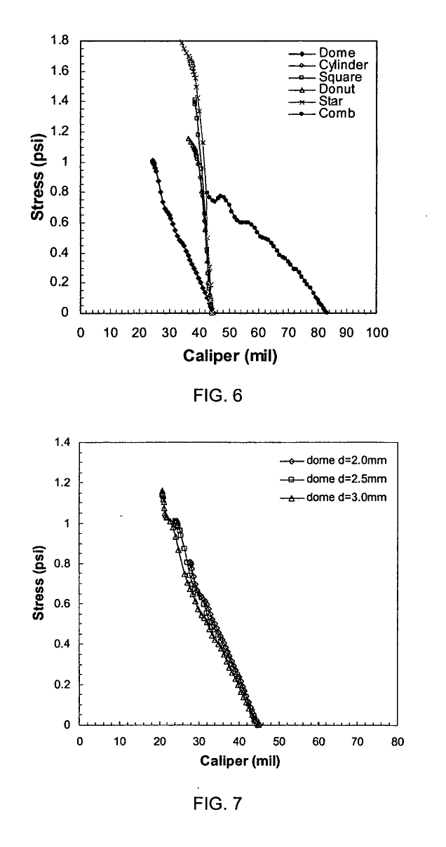

Some non dome-shaped elevated elements are also preferred because of their higher ability to retain the bulk of the tissue sheet when a compression force is applied in the z-direction. FIG. 5(a-f) shows six of these structures of domes (FIG. 5a), cylinders (FIG. 5b), squares (FIG. 5c), donuts (FIG. 5d), stars (FIG. 5e), and cylinder stacked domes (FIG. 5f). The results of the stress versus caliper under compression from the numerical modeling are shown in FIG. 6. The steep slope of the curves indicates the higher capability for resisting compression. It is demonstrated that all the structures with non dome-shaped elements provide higher compression resistance than dome-shaped elevated elements, resulting in further improved bulk retention. For example, when a web defining star-shaped elevated elements is subjected to a pressure of about 0.3 psi in the z-direction, the web can retain at least about 97% of its initial caliper. Also, when the web is subjected to a pressure in the z-direction of about 0.5 psi, the web can retain at least about 96% of its initial caliper.

When using different shaped elements or combination to form the aesthetic sheet topography, the compression resistance (or the slope of the compression curve) can be flexibly adjusted between that of domes and other shaped elements, such as those with vertical sidewalls, in order to have the desired bulk and bulk retention properties based on requirement. For instance, the total 25 elements per square inch can consist of 15 domes, 10 donuts to retain the caliper of the web at least about 90% of its initial caliper. This will make the topography design more flexible and one can easily adjust the number of different shaped elements to achieve the desired bulk and other properties according to the requirements.

When the web is rolled into a rolled tissue product, this compression resistance can improve the roll bulk of the tissue product. For example, when rolled, the molded tissue sheets are subjected to a pressure in the z-direction so that the web forms a somewhat firmly rolled tissue product. However, improved bulk in the tissue sheet leads to improved bulk in the rolled tissue product Furthermore, when unwound, the tissue sheets can retain their bulk because of the compression resistance and bulk retention of the sheets.

The elevated elements of the present disclosure can have an effective diameter of up to about 3 mm, such as from about 1 mm to about 3 mm. For example, in one particular embodiment, the elevated elements can have a diameter of from about 2 mm to about 3 mm, and more particularly about 2.5 mm. Also, the elevated elements can have an elevation of up to about 2 mm, such as from about 0.5 mm to about 1.5 mm. For example, in one particular embodiment, the elevated elements can have an elevation of from about 0.8 mm to about 1.2 mm, and more particularly about 1 mm.

The size and shape of the elevated elements can vary according to the particular design and use of the tissue product. However, the present inventors have found that the overall size, including both the diameter and elevation, of the dome-shaped elevated elements does not substantially affect the ability of the tissue sheet to retain its bulk or resist compression (see FIG. 7). For example, changes in the dome-shaped elevated elements only negligibly changes the sheet properties, including the ability to resist compression and retain bulk.

Furthermore, the location and spacing of the elevated elements does not substantially affect the ability of the sheet to retain bulk and resist compression. As such, the sheet need not have uniformly spaced elevated elements situated in rows or columns in order to provide the advantages of the presently disclosed sheets.

By molding the tissue web with the through-air dryer fabric, the entire tissue web can be molded into the same shape. As such, the resulting tissue product will define two surfaces that are substantially parallel to each other throughout the tissue web.

Use of the through-air dryer fabric to mold the tissue web allows the pattern molded into the tissue web to be easily changed during the tissue making process. For example, to change the pattern molded into the web, only the through-air dryer fabric needs to be changed. As such, the down time in the tissue making manufacture can be limited when the tissue web's molded pattern is changed.

Once the pressure roll 45 impresses the fibrous web 11 against the through-air dryer 21, the through-air dryer 21 can then accomplish the removal of moisture from the web 11 by passing air through the web without applying any mechanical pressure. Through-air drying can also increase the bulk and softness of the web. In one embodiment, for example, the through-dryer can contain a rotatable, perforated cylinder and a hood 50 for receiving hot air blown through perforations of the cylinder as the through-air drying fabric 19 carries the fibrous web 11 over the upper portion of the cylinder. The heated air is forced through the perforations in the cylinder of the through-air dryer 21 and removes the remaining water from the fibrous web 11. The temperature of the air forced through the fibrous web 11 by the through-air dryer 21 can vary, but is typically from about 250° F. to about 500°F. It should also be understood that other non-compressive drying methods, such as microwave or infrared heating, can be used. Moreover, if desired, certain compressive heating methods, such as Yankee dryers, may be used as well.

While supported by the through-air drying fabric 19, the web can then be dried to a consistency of about 95 percent or greater by the through-air dryer 21 and thereafter transferred to a carrier fabric 22. The dried basesheet 23 is then transported to from the carrier fabric 22 to a reel 24, where it is wound. An optional turning roll 26 can be used to facilitate transfer of the web from the carrier fabric 22 to the reel 24.

It should be understood that a tissue of the present invention can be a single ply or multi-ply tissue. When utilizing multi-ply tissues, one or more of the plies may be formed in accordance with the present disclosure. Moreover, in some instances, a multi-ply tissue made according to the present disclosure can be particularly useful to consumers. In particular, consumers often use more than one tissue at once, as such, multi-ply tissues can cut down on this practice.

In addition to the benefits and advantages discussed above, a tissue product of the present disclosure can also have a variety of other benefits as well. For instance, a tissue having elevated elements on a surface can increase the caliper of the tissue, which allows for the use of smaller elevated elements to provide a desired sheet thickness.

### EXAMPLES

Three-dimensional finite element models where developed of sheets having dome-shaped and other shaped elements. The models are believed to exactly simulate a tissue sheet having the same properties.

In each of the following models, a virtual sheet was created in the commercial finite element analysis software sold under the trade name ABAQUS® version 6.4 by ABAQUS, Inc. of Providence, R.I. Each sheet was given a topography as describe below and was treated as a thin layered shell of consistent thickness with 3-D surface topography. This virtual sheet was placed between two parallel rigid plates and subjected to compression from the top plate. The contact surfaces between the sheet and the plates were assumed to be frictional by specifying the coefficient of friction of 0.2. The sheet was squeezed to a very close distance between the two rigid plates by the movement of the top plate and the caliper reduced as the elements collapsed. The sheets plastic material properties allow it to have permanent deformation when the load goes beyond its material yield stress.

A. Dome-Shaped Elevated Elements

A model of a tissue sheet having dome-shaped elevated elements was produced like the tissue sheet of FIG. 5(a). The dome-shaped elements had a diameter of 2.5 mm and a height of 1 mm. The tissue sheet had an initial caliper (mil) of 45.00 in the z-direction.

The caliper of the sheet at 0.29 psi was 38.45 mi, which results in a caliper. loss of about 14.56% at 0.29 psi. Additionally, at 0.5 psi, the caliper of the sheet was 32.90, which indicates a caliper loss of 26.89% at 0.5 psi.

Also, models of domes with diameters of 2.0 and 3.0 mm, but having the same height, were tested. For example, the largest dome is 1.5 times greater in diameter than the smallest one, and its height to width ratio is about 34% less than that of the smallest one, 0.33 versus 0.5. So, the larger dome was not simply scaled from the smaller dome as the element height was kept unchanged. The domes with the 2.0 mm diameter had an initial caliper of 45.00 mils. Under pressure of 0.29 psi, the caliper was reduced to 38.64 mils, which indicates a 14.21% caliper loss at 0.29 psi. The caliper of the web at 0.5 psi was 33.87 mils, indicating a caliper loss at 0.5 psi of 24.80%. The model with domes having a diameter of 3 mm had an initial caliper of 45.00 mils. At a pressure of 0.29 psi, the caliper was reduced to 37.52 mils indicating a 16.62% loss in caliper. At a pressure of 0.5 psi, the caliper was reduced to 32.14 mils indicating a caliper loss of 28.58% at 0.5 psi.

Results of the caliper change at certain stresses are shown in FIG. 7. The steep slope of each of the lines indicates that the caliper does not change significantly with additional pressure on the web. Also, the similarity of the data at the different dome shapes indicates that the sheet will act in substantially the same manner no matter the diameter of the dome.

Elevated Elements Having at Least One Vertical Sidewall

B. Cylinder-Shaped Elevated Elements

A model of a tissue sheet having cylinder-shaped elevated elements was produced, like the tissue sheet of FIG. 5(b). The cylinder-shaped elements had a diameter of 2.5 mm and a height of 1 mm. The tissue sheet had an initial caliper (mil) of 44.37 in the z-direction.

The caliper of the sheet at 0.29 psi was 43.19 mil, which results in a caliper loss of about 2.66% at 0.29 psi. Additionally, at 0.5 psi, the caliper of the sheet was 42.34, which indicates a caliper loss of 4.58% at 0.5 psi.

C. Square-Shaped Elevated Elements

A model of a tissue sheet having square-shaped elevated elements was produced like the tissue sheet of FIG. 5(c). The square-shaped elements had a diameter of 2.5 mm and a height of 1 mm. The tissue sheet had an initial caliper (mil) of 44.06 in the z-direction.

The caliper of the sheet at 0.29 psi was 43.02 mil, which results in a caliper loss of about 2.36% at 0.29 psi. Additionally, at 0.5 psi, the caliper of the sheet was 42.39, which indicates a caliper loss of 3.79% at 0.5 psi.

D. Donut-Shaped Elevated Elements

A model of a tissue sheet having donut-shaped elevated elements was produced like the tissue sheet of FIG. 5(d). The donut-shaped elements had a diameter of 2.5 mm and a height of 1 mm. The tissue sheet had an initial caliper (mil) of 44.06 in the z-direction.

The caliper of the sheet at 0.29 psi was 42.83 mil, which results in a caliper loss of 2.79% at 0.29 psi. Additionally, at 0.5 psi, the caliper of the sheet was 42.12, which indicates a caliper loss of 4.40% at 0.5 psi.

E. Star-Shaped Elevated Elements

A model of a tissue sheet having star-shaped elevated elements was produced like the tissue sheet of FIG. 5(e). The star-shaped elements had a diameter of 2.5 mm and a height of 1 mm. The tissue sheet had an initial caliper (mil) of 44.29 in the z-direction.

The caliper of the sheet at 0.29 psi was 43.39 mil, which results in a caliper loss of 2.03% at 0.29 psi. Additionally, at 0.5 psi, the caliper of the sheet was 42.88, which indicates a caliper loss of 3.18% at 0.5 psi.

F. Combination of Dome and Cylinder-Shaped Elevated Elements

A model of a tissue sheet having a combination of dome and cylinder-shaped elevated elements was produced like the tissue sheet of FIG. 5(f). The combination of dome and cylinder-shaped elements had a diameter of 2.5 mm and a height of 2 mm. The tissue sheet had an initial caliper (mil) of 83.19 in the z-direction.

The caliper of the sheet at 0.29 psi was 72.28 mil, which results in a caliper loss of about 13.11% at 0.29 psi. Additionally, at 0.5 psi, the caliper of the sheet was 61.22, which indicates a caliper loss of 26.41% at 0.5 psi.

Results

FIG. 6 is a chart showing the results of these experiments for comparison of each shape.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A tissue product comprising:
an uncreped through-air dried paper web containing pulp fibers, said paper web defining a surface; said surface having elevated elements arranged in a pattern that defines a figure, said elevated elements having at least one vertical sidewall,
wherein said paper web has an initial bulk, and wherein said paper web retains at least about 75% of said initial bulk when subjected to a pressure of about 0.3 PSI.

2. A tissue product as in claim 1, wherein said paper web retains at least about 85% of said initial bulk when subjected to a pressure of about 0.3 PSI.

3. A tissue product as in claim 1, wherein said paper web retains at least about 95% of said initial bulk when subjected to a pressure of about 0.3 PSI.

4. A tissue product as in claim 1, wherein said paper web retains at least about 65% of said initial bulk when subjected to a pressure of about 0.5 PSI.

5. A tissue product as in claim 1, wherein said paper web retains at least about 75% of said initial bulk when subjected to a pressure of about 0.5 PSI.

6. A tissue product as in claim 1, wherein said paper web retains at least about 95% of said initial bulk when subjected to a pressure of about 0.5 PSI.

7. A tissue product as in claim 1, wherein said elevated elements have a diameter of from about 2 mm to about 3 mm.

8. A tissue product as in claim 1, wherein said elevated elements have an elevation of about 1 mm.

9. A tissue product as in claim 1, wherein said paper web defines perforations in the cross-machine direction of the web, said perforations being substantially uniformly spaced apart in the machine direction, and wherein the elevated elements are arranged in said paper web in designs that are registered between said perforations.

10. A tissue product comprising:
an uncreped throughair dried paper web defining a machine direction, a cross-machine direction, and a z-direction, said paper web being molded to include dome-shaped elevated elements in the z-direction, said paper web having an initial bulk, and retains at least about 75% of said initial bulk when subjected to a pressure of about 0.3 PSI,
wherein said paper web defines perforations in the cross-machine direction of the web, said perforations being substantially uniformly spaced apart in the machine direction, and wherein the dome shaped elements are arranged in said paper web in aesthetically pleasing designs that are registered between said perforations.

11. A tissue product as in claim 10, wherein said paper web retains at least about 85% of said initial bulk when subjected to a pressure of about 0.3 PSI.

12. A tissue product as in claim 10, wherein said paper web retains at least about 65% of said initial bulk when subjected to a pressure of about 0.5 PSI.

13. A tissue product as in claim 10, wherein said paper web retains at least about 70% of said initial bulk when subjected to a pressure of about 0.5 PSI.

14. A tissue product as in claim 10, wherein said dome-shaped elevated elements have a diameter of from about 2 mm to about 3 mm.

15. A tissue product as in claim 10, wherein said dome-shaped elevated elements have an elevation of about 1 mm.

16. A tissue product as in claim 10, wherein said paper web is molded to include elevated elements having at least one vertical sidewall in the z-direction.

17. A method of forming a molded a tissue web product having improved bulk retention, the method comprising:
providing a liquid furnish containing papermaking fibers;
depositing said furnish onto a foraminous surface to form a paper web;
transferring said paper web to a through-air drying nonwoven fabric having a three-dimensional surface contour that defines dome-shaped elevated elements;
molding said paper web to the three-dimensional surface contour of said through-air drying nonwoven fabric such that said paper web has elevated elements molded into the web in a design that defines a figure, wherein the elevated elements are selected from the group consisting of elevated elements having at least one vertical sidewall, dome-shaped elevated elements, and combinations thereof;
substantially drying said paper web with a dryer;
wherein said paper web formed by the method has an initial bulk, and retains at least about 75% of said initial bulk when subjected to a pressure of about 0.3 PSI.

18. A method as in claim 17, wherein said paper web retains at least about 95% of said initial bulk when subjected to a pressure of about 0.3 PSI.

19. A method as in claim 17, wherein said paper web retains at least about 75% of said initial bulk when subjected to a pressure of about 0.5 PSI.

20. A method as in claim 17, wherein said paper web retains at least about 95% of said initial bulk when subjected to a pressure of about 0.5 PSI.

21. A method as in claim 17, wherein said elevated elements have a diameter of from about 2 mm to about 3 mm.

22. A method as in claim 17, wherein said elevated elements have an elevation of about 1 mm.

23. A method as in claim 17 wherein the paper web defines a machine direction and a cross-machine direction, the method further comprising
perforating the paper web in the cross-machine direction such that the perforations are substantially equally spaced in the machine direction, wherein the figures defined by the elevated elements are registered between each perforation.

24. A method as in claim 17, wherein the elevated elements comprise a combination of elevated elements having at least one vertical sidewall and dome-shaped elevated elements, the method further comprising
selecting a combination of elevated elements to provide a web having a targeted bulk retention when compressed.
